(19) United States
(12) Patent Application Publication
(10) Pub. No.: US 2004/0065354 A1
(43) Pub. Date: Apr. 8, 2004

(54) Apparatus and method for substrate processing

(76) Inventors: Tadashi Ishizaki, Yokohama-shi (JP); Kazuyoshi Takeda, Kawasaki-shi (JP); Tohru Watari, Yokohama-shi (JP)

Correspondence Address: SLATER & MATSIL, L.L.P., 17950 PRESTON RD, SUITE 1000, DALLAS, TX, 75252-5793, US

(21) Appl. No.: 10/663,558

(22) Filed: Sep. 16, 2003

(30) Foreign Application Priority Data
Oct. 8, 2002 (JP) 2002-294562

(51) Int. Cl. B08B 3/00

(52) U.S. Cl. 134/30; 134/26; 134/31; 134/32; 134/33; 134/34; 134/94.1; 134/95.1; 134/95.2; 134/95.3; 134/99.1

(57) ABSTRACT

An apparatus and method are disclosed that can process a substrate such as a wafer while keeping high cleanliness. The apparatus comprises a center port 100, which is stationarily arranged in the center and on the surface of which at least one blow-off outlet is provided for blowing off fluid, and a rotating housing portion 200 which is capable of rotating about the center port 100. The rotating housing portion 200 comprises a top plate 210 comprising a main surface S2 that opposes a wafer W, and a lower housing being connected to the top plate 210 and rotatably driven by a rotation-driving member. When the surface S1 comprising blow-off outlets 151a and 153a of the center port 100 is offset from the main surface S2 of the top plate 210 and fluid is blown off from the blow-off outlet 151a, the substrate W is contactlessly held above the main surface S2 of the top plate 210 and the surface S1 of the center port 100.

### TECHNICAL FIELD

This invention relates to a substrate processing apparatus, and particularly to a substrate processing apparatus and method having the function of cleaning a substrate such as a semiconductor wafer.

### BACKGROUND

In semiconductor manufacturing process, the cleaning steps prior to thermal film-forming steps always require high cleanliness. As the most general approach under the circumstance, the processing by cleaning chemicals in the immersion approach has been currently used. The most advantageous point of this approach is that it is easy to process with a wafer jig, clean both upper and lower surfaces of a substrate, keep high cleanliness, and accommodate volume production.

In the needs of recent technical developments and marketplace, a higher density and improved performance of LSI chips will be required, and furthermore a larger wafer in diameter will be used to satisfy these requirements in future LSI manufacturing. To fulfill such needs, not only keeping high cleanliness but also reducing the cost of LSI manufacturing is required.

However, because the apparatus for the conventional immersion approach mentioned above is huge in size, the apparatus occupies a wider floor area, consumes a larger amount of chemicals, uses more equipment, and consumes larger amount of energy. Therefore, this approach does not necessarily match the needs in future LSI manufacturing.

These trends have led to the introduction of the single-wafer cleaning apparatus. However, the single-wafer cleaning apparatus has many problems to be addressed. From a mechanical aspect, problems are mainly found in the method for transferring wafers, the method for holding wafers during the cleaning, and the method for drying wafers. Furthermore, from the aspect of process, issues to be addressed include the establishment of techniques for cleaning both upper and lower surfaces of the wafers and the establishment of methods for preventing wafer contamination from impurities, foreign particles, or the like.

Various approaches have been made to these problems and many problem-solving methods have been appeared, but there is no decisive solution so far. Under present circumstances, the single-wafer cleaning apparatus is not considered to be appropriate for the steps that require high cleanliness, such as the cleaning steps prior to thermal film-forming steps. Especially in the steps for cleaning wafers, techniques have not yet developed that can complete a series of steps of transferring a wafer to cleaning position, holding the wafer, cleaning the wafer, and transferring the wafer from the cleaning position after cleaning the wafer, while keeping high cleanliness of the wafer. This has been the factor that considerably retarded the application of the single-wafer cleaning apparatus to high cleanliness steps.

### SUMMARY OF THE INVENTION

As a result of intensive studies conducted for the above mentioned problems involved in the single-wafer cleaning apparatus, the present inventors successfully developed a technique that can complete a series of steps from the step of transferring a wafer to cleaning position, the step of cleaning the wafer, to the step of carrying out the wafer, while keeping high cleanliness.

On aspect of the present invention provides a substrate processing apparatus and method thereof that can process a substrate such as a wafer while keeping high cleanliness.

Another aspect of the present invention provides a single-wafer type of wafer cleaning apparatus that can clean a substrate such as a wafer while contactlessly holding the substrate.

Yet another aspect of the present invention provides a substrate processing apparatus that suppresses particle generation and has an anti-corrosion structure.

A substrate processing apparatus according to a first embodiment of the present invention comprises a fluid-providing means which is stationarily arranged and on the surface of which at least one blow-off outlet is provided for blowing off fluid and a rotating member which is capable of rotating about said fluid-providing means, wherein said rotating member comprises a first rotating member having a main surface that opposes the substrate to be processed and a second rotating member that is connected to said first rotating member and rotatably driven by a rotation-driving member, and wherein said substrate is contactlessly held above the main surface of said first rotating member and the surface of said fluid-providing means when the surface of said fluid-providing means comprising said at least one blow-off outlet is offset below the main surface of said first rotating member and fluid is blown off from said at least one blow-off outlet. By offsetting the surface that comprises the blow-off outlet below the main surface of the first rotating member, turbulent flow between the surface and the substrate can be suppressed, resulting that vibrations of the substrate and noise can be suppressed and the particle generation can be minimized.

Preferably, the amount of the offset between the surface comprising at least one blow-off outlet and said main surface of said first rotating member is 2 mm or less.

A substrate processing apparatus according to a second embodiment of the present invention comprises a fluid-providing means which is stationarily arranged and on the surface of which a plurality of blow-off outlets are provided for blowing off fluid and a rotating means which is capable of rotating about said fluid-providing means. Said rotating means comprises a first rotating member having a surface that opposes the substrate and a second rotating member that is connected to said first rotating member and is rotatably driven. The plurality of blow-off outlets comprise a first blow-off outlet located in the center and a second blow-off outlet located about said first blow-off outlet, wherein said substrate can be contactlessly held above said first rotating member by blowing off gas from the first blow-off outlet, and wherein liquid can be blown off from said second blow-off outlet toward said contactlessly held substrate. As such, the substrate can be cleaned while being held contactlessly, and therefore high cleanliness of the substrate can be maintained.

Preferably, said second blow-off outlet is more than one and located about said first blow-off outlet, and desirably located at equally spaced intervals. In addition, the substrate processing apparatus may comprise a nozzle above the rotating means for providing cleaning liquid to the upper surface of the substrate that is held contactlessly so that the cleaning of both upper and lower surfaces of the substrate can be performed.

A substrate processing apparatus according to the present invention comprises a fluid-providing means comprising a first and a second diameters, wherein a plurality of blow-off outlets are formed on the surface of said first diameter and a first labyrinth seal portion is formed on the surface of said second diameter, and the fluid-providing means further comprising a providing port that is capable of providing fluid to at least said plurality of blow-off outlets, and said substrate processing apparatus further comprises a rotating member that is rotatably mounted to said fluid-providing means. The rotating member comprises a main surface, in the center of which a through hole is formed, wherein the surface of said first diameter of said fluid-providing means is located in said through hole, and said rotating member further comprises a second labyrinth seal portion that fits the first labyrinth seal portion. A first aperture is formed in the first labyrinth seal portion and said first aperture is connected through a first path to said providing port. A second aperture is formed in the second labyrinth seal portion and said second aperture is connected to a second path, wherein said first aperture and said second aperture are spaced apart. By preventing the apertures of the labyrinth seal portions from overlapping when the rotating member rotates, fluctuations in volume of the seal portions can be suppressed, and therefore gas pulsation can be suppressed.

The fluid provided from the providing port flows through said first path, said first aperture, and said first and second labyrinth seal portions, and flows out through a gap between the surface of said first diameter and said through hole. This prevents the entry of a chemical solution or the like from the gap.

Preferably the second aperture comprises a plurality of apertures, and said second path comprises a plurality of paths connected to said plurality of apertures. On the side portion of said rotating member, a plurality of fluid-draining outlets are formed. Said plurality of paths extend in radial directions respectively and are connected to said plurality of fluid-draining outlets. The fluid provided from said providing port flows through said first path, said first aperture, and said first and second labyrinth seal portions, and through said second aperture and said second path, and can be drained from said fluid-draining outlets. Hereby, it is possible to prevent a chemical solution or the like from entering inside, and even if it enters, the inside can be protected from contaminant such as the chemical solution by draining the chemical solution or the like from the draining outlets.

A substrate processing apparatus according to another embodiment of the present invention comprises a holding plane comprising a surface on which a plurality of blow-off outlets are formed and which is held stationary and a main surface which rotates about said surface, and a fluid-providing means for providing fluid to said plurality of blow-off outlets, wherein, by contactlessly holding a substrate above said holding plane by the fluid that is blown off from at least one blow-off outlet of said plurality of blow-off outlets and by blowing off a cleaning chemical solution from at least one blow-off outlet of said plurality of blow-off outlets, one surface of the substrate that is held contactlessly is cleaned. Hereby, the cleaning of the substrate can be performed while keeping high cleanliness of the substrate.

A substrate processing method according to yet another embodiment of the present invention comprises the step of placing a substrate above a holding plane comprising a surface on which a plurality of blow-off outlets are formed and a main surface which rotates about said surface, the step of blowing off inert gas from at least one blow-off outlet of said plurality of blow-off outlets for contactlessly holding said substrate above said holding plane, and the step of blowing off a chemical solution from at least one blow-off outlet of said plurality of blow-off outlets for cleaning the substrate. Preferably, after these steps, the method comprises the step of rinsing the substrate by pure water, and the step of rotating the substrate while blowing off inert gas such as nitrogen gas after the rinsing step. Hereby, a series of processing from cleaning to drying of a substrate can be performed successively at a position.

The substrate to be processed by the substrate processing apparatus is preferably a semiconductor wafer. However, besides semiconductor wafers, the apparatus is applicable to other substrates, such as glass substrates for liquid crystal display or glass substrates for plasma display.

The semiconductor wafer is held substantially contactlessly by using the Bernoulli Effect, and cleaned. At least one surface of the semiconductor wafer is atmospherically controlled with inert gas such as nitrogen gas, and the wafer is cleaned in this state. Therefore, throughout the processes from cleaning, transferring, to drying of the semiconductor wafer, the semiconductor wafer is kept substantially under an inert gas atmosphere and the wafer can be protected from particle contamination and the exposure of the wafer to the air can be suppressed to the utmost. By the use of a non-contact holding (chuck) by using the Bernoulli Effect as a means for transferring the substrate such as a wafer, the above mentioned effects can be enhanced.

### BREIF DESCRIPTION OF THE DRAWINGS

For a more complete understanding of the present invention, and the advantages thereof, reference is now made to the following descriptions taken in conjunction with the accompanying drawing, in which:

FIG. 1 is a plan view of a wafer cleaning apparatus according to an embodiment of the present invention;

FIG. 2 is a cross-sectional view taken along line X-X of FIG. 1;

FIG. 3a is a plan view of a center port;

FIG. 3b is a cross-sectional view taken along line X1-X1 of FIG. 3a;

FIG. 3c is a rear plan view of the center port;

FIG. 3d is a cross-sectional view taken along line X2;

FIG. 4a is a cross-sectional view of a top plate taken along line X3-X3, and FIG. 4b is a plan view of the top plate;

FIG. 5a is a plan view of a main shaft, and FIG. 5b is a cross-sectional view taken along line X4-X4;

FIG. 6a is a plan view of a crown gear, and FIG. 6b is a cross-sectional view taken along line X5-X5;

FIG. 7 shows the relationship between the surface S1 of the center port and the main surface S2 of the top plate;

FIGS. 8a, 8b and 8c show various relationships between the surface S1 of the center port and the main surface S2 of the top plate;

FIG. 9 is a cross-sectional view showing the structure of a holding tool;

FIG. 10a is a plan view of a labyrinth seal portion of the center port;

FIG. 10b is a plan view of a labyrinth seal portion of the top plate;

FIG. 10c is a cross-sectional view of the labyrinth seal portions;

FIG. 11 is an example for comparison with FIG. 10;

FIG. 11a is a plan view of a labyrinth seal portion of the center port;

FIG. 11b is a plan view of a labyrinth seal portion of the top plate; and

FIG. 11c is a cross-sectional view of the labyrinth seal portions.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

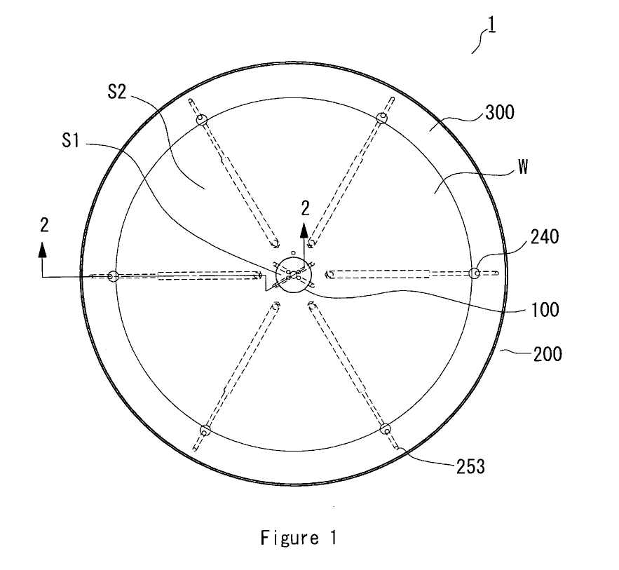

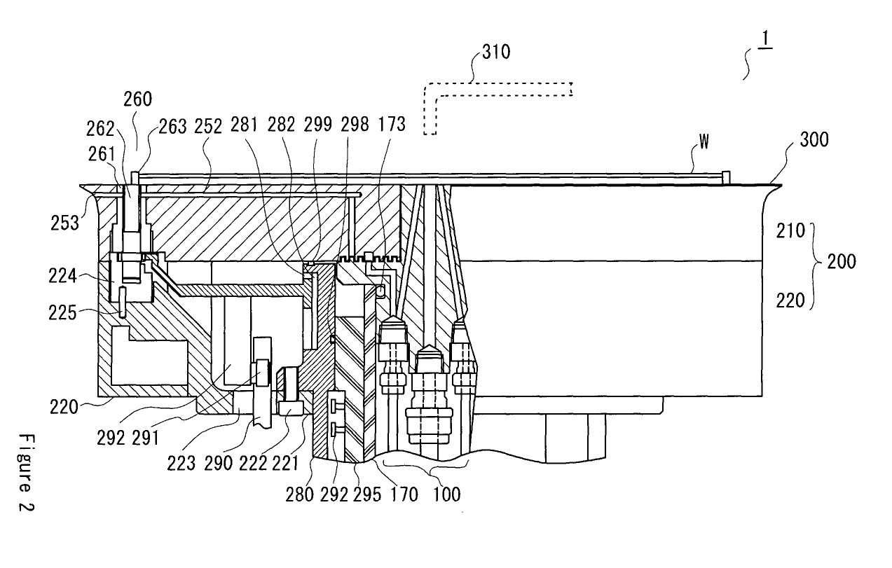

A semiconductor wafer cleaning apparatus according to an embodiment of the present invention will be now described. FIG. 1 shows a plan view of a wafer cleaning apparatus according to the present embodiment. FIG. 2 shows a cross-sectional view taken along line 2-2 of FIG. 1. A wafer cleaning apparatus 1 according to the this embodiment of the present invention comprises a center port 100 that is located approximately in the center and provides fluid such as gas or liquid, and a rotating housing portion 200 that rotates about the center port 100. The center port 100 and the rotating housing portion 200 form a wafer holding plane 300 and contactlessly hold a semiconductor wafer W above the wafer holding plane 300 by using the Bernoulli Effect.

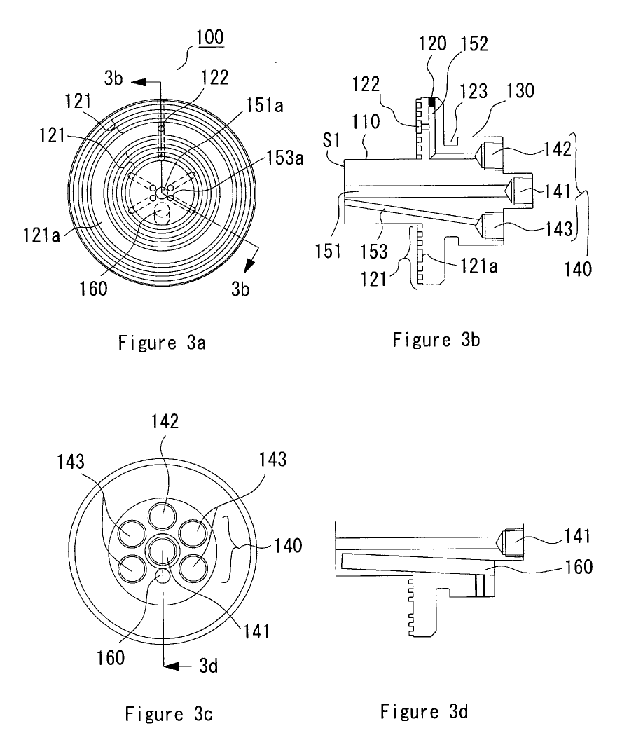

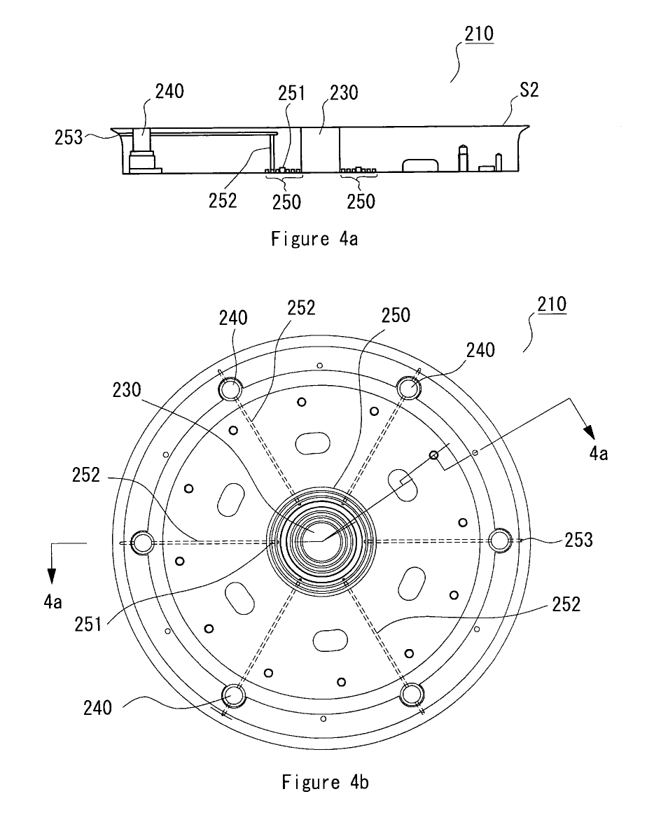

FIGS. 3a, 3b, 3c and 3d, collectively FIG. 3, show the structure of a center port and FIGS. 4a and 4b shows the structure of a top plate. Center port 100 is stationarily fixed to a body (not shown) of the cleaning apparatus 1. As shown in FIG. 3, the center port 100 comprises a cylindrical blow-off portion 110 having a radius of r1, a seal portion 120 having a radius of r2 (r2>r1), and an extending portion 130 that extends downwardly below the seal portion 120. In the extending portion 130, a plurality of ports 140 is formed for providing gas or liquid. Inert gas such as nitrogen gas is provided into a central port 141 and a port 142 adjacent thereto, and chemical solutions or pure water, which are necessary for cleaning the wafer, are provided into the remaining four ports 143.

Along the central axis of the center port 100, a gas-providing path 151 is formed. One end of the gas-providing path 151 is connected to the central port 141 in the extending portion 130, and the other end forms a blow-off outlet 151a on a surface S1 of the blow-off portion 110. In the center port 100, four liquid-providing paths 153 are further formed corresponding to the four ports 143, and these liquid-providing paths 153 are tilted so as to converge toward the surface S1 of the blow-off portion 110. On the surface S I of the blow-off portion 110, four blow-off outlets 153a are formed. Gas-providing path 152 corresponding to the remaining port 142 is bent perpendicularly from the extending portion 130 to the seal portion 120 and connected to an aperture 122 of a labyrinth seal portion 121 that is formed on a surface of the seal portion 120. Labyrinth seal portion 121 comprises a plurality of concentric, annular concave portions or convex portions on the surface of the seal portion 120, and the aperture 122 is formed approximately in the center of them on the surface.

Center port 100 is preferably made of Teflon (registered trademark), and it is desirable to use tubes that are made of fluorine resin preferably such as Teflon (registered trademark) for the gas-providing paths 151, 152 and the liquid-providing paths 153. The use of such tubes enhances anti-corrosive characteristics, and moreover, generation of particles or the like can be suppressed.

Further formed in the center port 100 is a sensor groove 160, to which a sensor for detecting the wafer W is mounted. Sensor groove 160 extends toward the surface S1 of the blow-off portion 110, but the tip of the groove stops before and is not connected to the surface S1. Whether or not the wafer W exists above the blow-off portion 110 is detected, for example, by radiating infrared rays in the sensor groove 160 and providing a sensor that contains a photo diode or the like for detecting the reflected light from the radiation.

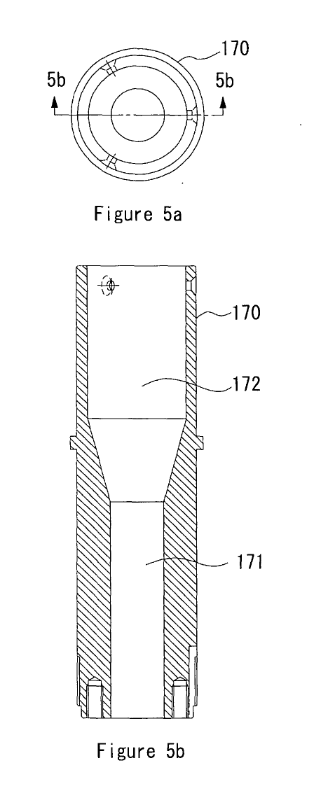

The center port 100 is inserted and fixed in a main shaft 170 as shown in FIGS. 5a and 5b. Main shaft 170 has a cylindrical shape and in which spaces 171, 172 having different diameters are formed. Extending portion 130 of the center port 100 is inserted in the space 172 of the main shaft 170. In a concave portion 123 formed between the seal portion 120 and the extending portion 130, an O-ring 173 is inserted (see FIG. 2). O-ring 173 prevents particles, dusts or the like, which are generated in the center port 100, from moving into the rotating housing portion 200. In the space 171, fluid-providing tubes being connected to the ports 141, 142 and 143 are located, which are connected to a fluid-providing source (not shown). The cleaning apparatus 1 according to this embodiment of the present invention allows reduction in size of the apparatus and minimizes unwanted particle generation, by stationarily arranging the center port 100 and providing a fluid-providing means therein.

Rotating housing portion 200 comprises a top plate 210 and a lower housing 220 that is connected to the top plate 210, which are rotated about the center port 100. Top plate 210 has a shape like a disk as shown in FIGS. 4a and 4b and is made of fluorine resin such as Teflon (registered trademark). Top plate 210 has a flat main surface S2 and in the center of which a through hole 230 is formed. A plurality of holes 240 is formed at 60° intervals in the circumferential direction of the main surface S2. On the lower surface of the top plate 210, a labyrinth seal portion 250 is formed. Labyrinth seal portion 250 has a plurality of concentric, convex portions or concave portions in the center of the top plate 210. In addition, in the labyrinth seal portion 250, a plurality of apertures 251 are formed at equally spaced intervals. To the apertures 251, paths 252 radially extending from the center of the top plate 210 to its periphery are connected respectively. The paths 252 intersect a plurality of holes 240 respectively and are connected to draining outlets 253 that are formed on the side of the top plate 210.

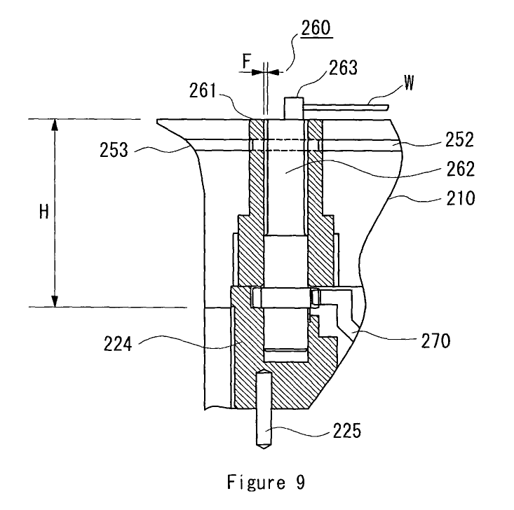

At the position of the plurality of holes 240 of the top plate 210, a holding tool 260 is mounted (see FIG. 2 and FIG. 9). A cylindrical pin case 261 is fixed in the hole 240, and the holding tool 260 is mounted in the pin case 261. Holding tool 260 has a body 262 and a protrusion 263 that is eccentric with respect to the center of the body 262, and the protrusion 263 protrudes from the main surface S2. The body 262 engages a crown gear 270 and is rotated by the rotation of the crown gear 270. As such, the protrusion 263 is rotated above the main surface S2.

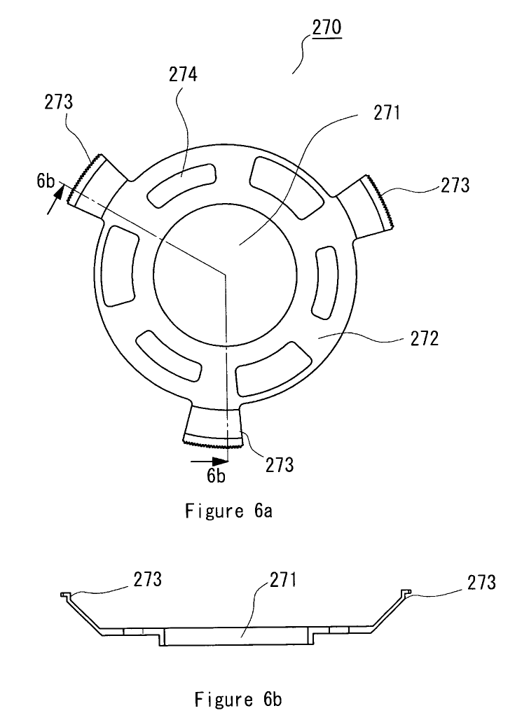

FIGS. 6a and 6b show the structure of the crown gear 270. Crown gear 270 has a gear body 272, in the center of which an aperture 271 is formed, and three gear portions 273 that extend slantingly upward from the gear body 272. In the gear body 272, apertures 274 are formed in the circumferential direction, with which a junction block 292 (which will be mentioned later) is fitted. Three gear portions 273 are engaged with the body 262 of the holding tool to rotate the body 262.

Referring to FIG. 2, the lower housing 220 is fixed to the top plate 210 by members such as bolts (not shown), and a flange portion 221 of the lower housing 220 is fixed by a shoulder portion of a cylindrical flange member 280 and by a bolt 222. On the lower surface of the lower housing 220, an aperture 223 is formed, through which an open/close cam 290 is inserted. On the mating surface between the lower housing 220 and the top plate 210, a concave portion 224a is formed to accommodate a lower pin case 224. The lower pin case 224 is fixed to the lower housing 220 by a pin 225 in the concave portion 224a, and the end of the lower pin case 224 is connected to the pin case 261.

Flange member 280 is fixed by a rotating member 295 and parallel keys 280a. In the mating surface between the flange member 280 and the rotating member 295, an O-ring 298 is interposed. On the sidewall of the flange member 280, a concave portion 281 is formed in which a cylindrical spacer 282 is mounted. The spacer 282 is inserted in the aperture 271 of the crown gear 270, and rotatably fitted with the crown gear 270. In addition, an O-ring 299 is interposed between the top of the flange member 280 and the lower surface of the top plate 210.

Open/close cam 290 that is inserted through the aperture 223 is connected to an air cylinder (not shown) that allows the open/close cam 290 to operate in vertical reciprocating motion. Roller 291 is rotatably mounted to a junction block 292 and is connected to the cam surface of the open/close cam 290. When the open/close cam 290 moves in a vertical direction, the roller 291 follows the cam surface and moves to a direction perpendicular to the direction of the movement of the open/close cam 290 (the direction perpendicular to the figure). The end of the junction block 292 is fitted with either one of the above mentioned apertures 274 of the crown gear 270 to rotate the crown gear 270 in synchronous to the movement of the open/close cam 290. As such, the holding tool 260 rotates about the center port 100 together with the top plate 210, and the eccentric protrusion 263 of the holding tool 260 rotates above the main surface S2.

Rotating member 295 is rotatably fitted with the main shaft 170 via a ball bearing (not shown). The rotating member 295 is linked to a rotation-driving mechanism by a rotating belt or the like, which is not shown. When the rotating member 295 is rotated, the flange member 280 and the rotating housing portion 200 comprising the lower housing 220 and the top plate 210, which are linked to the rotating member 295, are rotated about the center port 100.

Top plate 210 has a main surface S2 having an area same as or larger than that of the wafer W. The top plate 210 should not be worn due to friction or contact with the center port 100 or the like when high speed rotation is required, for example a revolution at about 1000 rpm or more. Therefore, the top plate 210 has a gap between it and the center port 100. When the top plate 210 is disposed above the center port 100 as shown in FIG. 2, the labyrinth seal portion 250 of the top plate 210 is fitted with the labyrinth seal portion 121 of the center port 100 so that a non-contact rotating seal is formed. The blow-off portion 110 of the center port 100 is located in the through hole 230 of the top plate 210, and the holding plane 300 for contactlessly holding the wafer W is formed by the surface S1 of the blow-off portion 110 and the main surface S2 of the top plate 210.

The operations and detailed structure of each portion of the cleaning apparatus will be now described. In the step of cleaning the wafer W, inert gas such as nitrogen gas is provided from a gas-providing source to the ports 141 and 142 of the center port 100. Rotating housing portion 200 is rotated by a rotation-driving mechanism for example at about 1000 rpm.

The inert gas provided to the port 141 is blown off from the blow-off outlet 151a via the gas-providing path 151. The inert gas blown off from the blow-off outlet 15 la flows at about 100 NL/min or less, preferably about 20-80 NL/min, and optimally about 40-75 NL/min. In the state where the inert gas flows, wafer W is transferred to above the holding plane 300 by a transfer arm (not shown) or the like, and the wafer W is held apart from the holding plane 300 by the Bernoulli Effect when the holding of the wafer W by the arm is released. Wafer W is rotated at approximately same speed as the rotating housing portion 200, and the movement of the wafer W in a horizontal direction is regulated in a certain range by the holding tool 260 (protrusion 263). The non-contact holding of the wafer W can be performed by using air-bearing effect instead of the Bernoulli Effect.

The inert gas simultaneously provided from the port 142 of the center port 100 is provided to the labyrinth seal portion 121 via the gas-providing path 152. The inert gas flows through the aperture 122 formed in the labyrinth seal portion 121 and through the gap between the labyrinth seal portions 121 and 250, and one of which is delivered into the path 252 of the top plate 210 via the plurality of apertures 251 formed in the labyrinth seal portion 250 and the other of which is delivered into the gap between the blow-off portion 110 and the through hole 230 of the top plate 210 and flows out on the holding plane 300. The inert gas delivered into the path 252 of the top plate 210 is blown off from the gap between the holding tool 260 and the hole 240 to the main surface S2, and drained off from the draining outlet 253 formed on the side of the top plate 210. As such, the inert gas provided from the port 142 removes particles or the like from the holding plane 300, and keeps the environment surrounding the wafer W in the high cleanliness, and effectively prevents a chemical solution or the like from entering inside from the holding plane 300.

After the wafer W is contactlessly held by using the Bernoulli Effect, the wafer W is cleaned. In the present embodiment, either one or both of the upper surface and the lower surface of the wafer W can be cleaned.

In the case of cleaning the lower surface of the wafer W, a cleaning chemical solution is provided from the port 143 to the liquid-providing path 153. For example, by monitoring the output of a wafer detecting sensor mounted on the center port 100, the chemical solution can be automatically provided after a predetermined time has elapsed from the time the sensor detects that the wafer W is held. Alternatively, a user can input an instruction to the cleaning apparatus 1 to start cleaning.

The cleaning chemical solution can be selected as appropriate depending on cleaning conditions. For example, the chemical solution that can be used includes: an alkaline mixture solution consisting of such as ammonia solution, hydrogen peroxide solution, and ultra pure water; an acidic mixture solution consisting of such as hydrofluoric acid, hydrochloric acid, or hydrogen peroxide solution that are diluted with ultra pure water, and ultra pure water; or pure water for rinsing. Cleaning solution is blown off from the blow-off outlet 153a to approximately center of the wafer W, and the cleaning solution moves from the center of the wafer to periphery by the centrifugal force, and the lower surface of the wafer is cleaned. On the other hand, in the case of cleaning upper surface of the wafer simultaneously or cleaning the upper surface only, the chemical solution or the like is dropped from a nozzle 310, and the upper surface of the wafer W is cleaned. The cleaning process can be a known process such as the SC-1 or SC-2 process or a rinsing process.

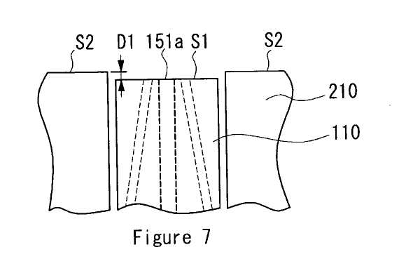

FIG. 7 shows the relative positioning of the surface S1 of the blow-off portion 110 and the main surface S2 of the top plate 210. As shown in FIG. 7, the surface S1 of the blow-off portion 110 is offset such that it is slightly below the main surface S2 of the top plate 210. The offset amount D1 is preferably approximately 2 mm or less. The reason for offsetting the surface S1 is as follows. If the surface S1 is set to be flush with the main surface S2 of the top plate 210, the space formed by the surface S1, main surface S2 and the wafer W creates resonance against the flow of inert gas from the blow-off outlet 151a, which vibrates the wafer W and thus particles or noise can be occurred. It is proved that the resonance against the flow of inert gas can be prevented by slightly offsetting the surface SI of the blow-off portion 110 from the main surface S2.

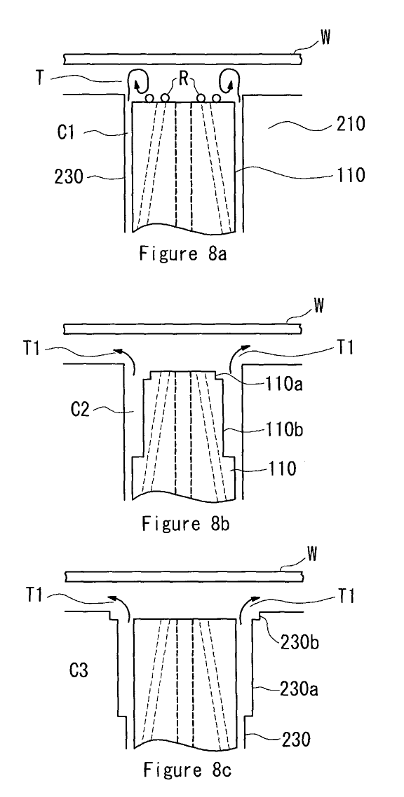

FIG. 8 shows an example in which the relative positioning of the blow-off portion 110 and the top plate 210 shown in FIG. 7 is further improved. The surface of the top plate 210 for cleaning the lower surface of the wafer W is desirably extremely flat. However, as shown in FIG. 8a, there may be a case where the presence of the gap C1 between the through hole 230 of the top plate 210 and the blow-off portion 110 causes a turbulent flow T in the flow of inert gas (provided from the port 142) that flows from the labyrinth seal portions 121 and 250. The turbulent flow T occurs in the space formed by the surface S I of the center port 100, the main surface S2 of the top plate 210, and the lower surface of the wafer W. And there is a fear that the turbulent flow T may flow backward through the gap C1 between the blow-off portion 110 and the through hole 230. In such cases, there is a possibility that the cleaning solution or rinsing solution which are used for the cleaning remain on the surface S1 of the blow-off portion 110 as residues R, or that the residues R flow into the gap C1 between the blow-off portion 110 and the through hole 230 due to the backward flow T.

Therefore, the outline shape of the blow-off portion 110 can be modified as shown in FIG. 8b. Blow-off portion 110 has a first small diameter portion 110a (shoulder portion) and a second small diameter portion 110b (shoulder portion), wherein the diameter becomes smaller nearer the surface S1. First small diameter portion 110a is approximately 80% of the diameter of the blow-off portion 110, and the second small diameter portion 110b is approximately 90% of the diameter of the blow-off portion 110. In addition, the second small diameter portion 110b forms a step height of approximately 15 mm or more from the surface S1. By gradually reducing the outer dimensions of the blow-off portion 110, the gap C2 between the blow-off portion 110 and the top plate 210 is increased, resulting that the space between the blow-off portion 110 and the top plate 210 is expanded. The expansion of the space is preferably approximately 1000 mm3 or more. Hereby, the turbulent flow that occurs between the rotating top plate 210 and the stationary center port 100 can be reduced, and the draining of the liquid gathered near the blow-off outlet due to the turbulent flow can be suppressed. This allows the inert gas to smoothly flow in the gap C2 as shown by the arrows T1, resulting that the entry of a chemical solution or rinsing solution from the gap C2 between the blow-off portion 110 and the top plate 210 can be prevented.

FIG. 8c shows an example where the space between the blow-off portion 110 and the top plate 210 is expanded by modifying the inner diameter of the through hole 230 of the top plate 210. The inner diameter of the through hole 230 has a first portion 230a (shoulder portion) and a second portion 230b (shoulder portion), wherein the diameter becomes larger nearer the surface S2. First portion 230a is larger than the inner diameter of the through hole 230, and the inner diameter of the second portion 230b is larger than the inner diameter of the first portion 230a. As such, by increasing the gap C3 between the blow-off portion 110 and the top plate 210 and expanding the space between them, a similar effect to that shown in FIG. 8b can be obtained.

FIG. 9 shows the detailed structure of the holding tool 260. Holding tool 260 is accommodated in the pin case 261 in the hole 240 of the top plate 210. The pin case 261 is connected to the lower pin case 224 of the lower housing 220. The body 262 of the holding tool 260 engages the crown gear 270 and is rotated. Therefore, a slight gap F is formed between the body 262 and the pin case 261. The gap F is typically about 1 mm or less, and preferably about 0.5 mm or less. Because of the presence of the gap F, there is a fear that a cleaning chemical enters from the gap F between the main surface S2 of the top plate 210 and the holding tool 260 during the cleaning of the wafer W. To cope with this problem, inert gas such as nitrogen which is provided from the aperture 251 of labyrinth seal portion 250 and from the path 252 is used so that the inert gas is purged out from the gap F or from the draining outlet 253. Hereby, it is possible to prevent the cleaning chemical that flows into the gap F between the holding tool 260 and the top plate 210 from entering inside, and also to emit particles or the like that occurred at the rotation-driving portion not to remain.

The holding tool 260 is composed of such as fluorine resin, for example Teflon (registered trademark), to prevent corrosion. Top plate 210 has a flat main surface S2 whose thickness should be about 10 mm or more to prevent the top plate from deforming during its flattening process. In addition, the wafer cleaning process includes hot cleaning chemical processing at near 80° C., which may cause the holding tool 260 or the top plate 210 to deform due to the heat. In order to prevent the wafer holding function from impairing due to heat deformation, the thickness of the top plate 210 should be much thicker. For these reasons, the thickness H of the top plate 210 should be at least about 15 mm or more, and is preferably about 20 mm-30 mm, and the optimum value is about 23 mm-27 mm. By using the thickness H of the 210 obtained as mentioned, the standard position of the holding tool 260 will not vary due to the heat deformation. Furthermore, in consideration of the amount the top plate 210 expands outward due to the heat deformation, the gap F between the holding tool 260 and the top plate 210 is about 0.5 mm.

Next, the labyrinth seal portion is described. The particles from the driving portion, which rotates the rotating housing portion 200, may occur near the main surface S2 of the top plate 210 or near the holding tool 260 through the labyrinth seal portions 121, 250 and the paths 252, and may contaminate the wafer W during the processing of the wafer. Therefore, O-rings 298 and 299 as shown in FIG. 2 are disposed, which effectively prevent particles from entering the spinner holding plane 300.

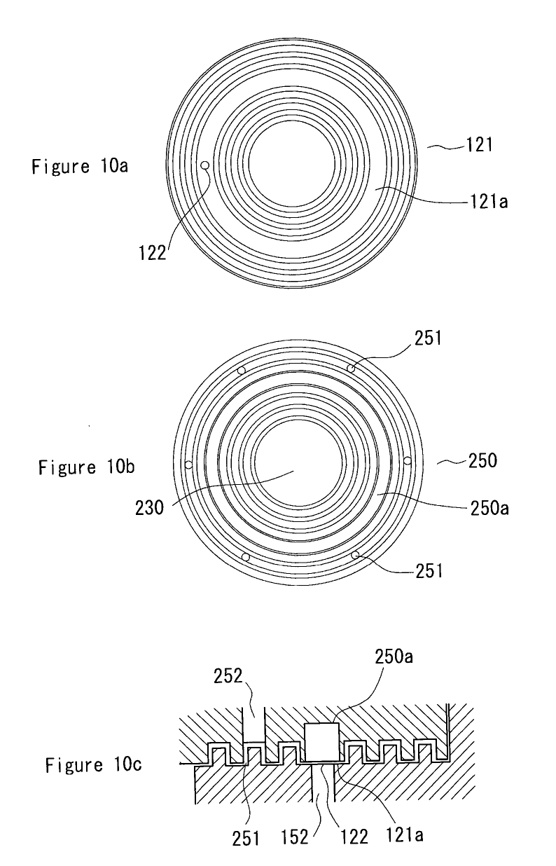

In this embodiment, in connection with the disposition of the 0-rings 298 and 299 mentioned above, the gas paths 252 on the labyrinth seal portion 250 side are offset in the direction of the periphery. FIG. 10a is a plan view of the labyrinth seal portion 121 formed on the center port 100, and FIG. 10b is a plan view of the labyrinth seal portion 250 formed on the top plate 210, and FIG. 10c is a cross view of the labyrinth seal portions.

Labyrinth seal portion 121 has a plurality of annular, convex portions or concave portions on the surface. At almost midpoint of them, a recess 121a forming a relatively large space is formed, and an aperture 122 is formed on the recess 121a. The aperture 122 is connected to the port 142 through the gas-providing path 152. On the other hand, the labyrinth seal portion 250 of the top plate 210 has a plurality of annular, concave portions or convex portions on the surface. At almost midpoint of them, a recess 250a forming a relatively large space is formed and six apertures 251 are formed at intervals of 60° in the circumferential direction outer than the recess 250a. These apertures 251 are connected to paths 252 respectively. The radial distance to the point where apertures 251 are formed is longer than the radial distance to the point where the aperture 122 is formed. Therefore, when the labyrinth seal portion 121 and 250 form a non-contact seal as shown in FIG. 10c, the recess 121a and the recess 250a are in a corresponding position, however, the apertures 251 are offset outer than the aperture 122. The inert gas from the gas-providing path 152 is delivered from the apertures 251 to the gas path 252 through the aperture 122, the recess 121 a and the recess 250a.

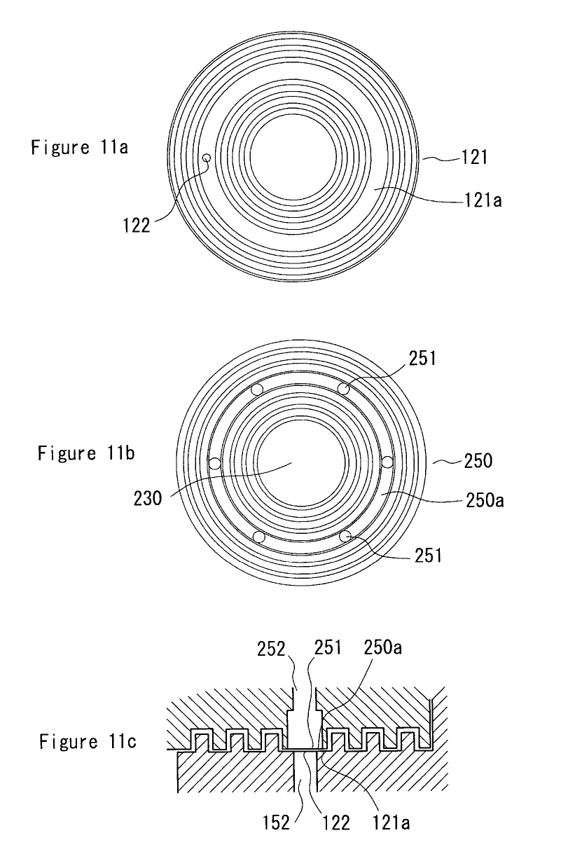

FIG. 11c shows an example where the aperture 251 of the labyrinth seal portion 250 coincides with the aperture 122 of the labyrinth seal portion 121. In other words, the aperture 122 is on the recess 121a and the apertures 251 are on the recess 250a. In the case where O-rings 298 and 299 are interposed in such labyrinth seals, the balance of the flowing pressure of inert gas is lost when the aperture 122 and the apertures 251 are in a position to overlap each other as shown in FIG. 11c. That is, by the rotation of the top plate 210, the paths 252 and the apertures 251 of the labyrinth seal portion 250 temporary overlap the path 152 and the aperture 122 of the labyrinth seal portion 121, where an area having a large volume is created. This causes variation in the pressure of the inert gas that flowed in, which causes gas pulsation. The gas pulsation may impair the sealing effect of the labyrinth seals when contactlessly holding the wafer W by using the Bernoulli Effect. In contrast to this, as shown in FIG. 10, by preventing the apertures 251 and paths 252 from directly overlapping the aperture 122 and the gas path 152, the volume in the labyrinth seal portions can be kept constant and the variation in the gas pressure and gas pulsation can be prevented.

As discussed above, the wafer W can be protected to the utmost because the wafer cleaning apparatus of the present embodiments permits the cleaning of each one or both of the lower surface and upper surface of the wafer W by rotating the wafer W while contactlessly holding it. After cleaning the wafer W, rinsing step and drying step are performed successively while contactlessly holding the wafer W. In the rinsing step, pure wafer is provided from the port 143 to the liquid-providing paths 153. The pure wafer is blown off from the blow-off outlets 153a toward the lower surface of the wafer W, and the lower surface of the wafer W is rinsed. By concurrently dropping pure water from the nozzle 310, the upper surface of the wafer W can also be rinsed. After the rinsing step, drying step of the wafer W is performed by blowing off inert gas, which is provided from the port 143 and comprises nitrogen gas or the like at approximately room temperature, from the blow-off outlets 153a. As described above, a series of steps from cleaning to drying can be performed successively while the wafer W is held contactlessly. During these steps, the wafer W is not substantially exposed to the air and kept under the high cleanliness environment. In addition, by employing the above mentioned series of steps of the present invention in a combination with a wafer transfer mechanism by using Bernoulli Effect and with vacuum heat drying, it is possible to suitably select upper-and-lower-surface cleaning, lower surface cleaning, or upper surface cleaning, while keeping the wafer in the high cleanliness. Furthermore, particles or residues of cleaning chemicals can be effectively emitted, by stationarily keeping the structure of the center port 100 for providing gas or liquid, rotating the structure of the rotating housing portion 200 including the top plate, and then blowing off inert gas from center of the holding plane 300 (surface S1 and main surface S2) toward periphery. In addition, by emitting inert gas also from the gap between the holding tool 260 and the top plate 210, the entry of chemicals or the like therefrom can be prevented.

Although preferred embodiments of the present invention are described in detail, the invention is not necessarily limited to such specific embodiments. Various alternations and modifications can be made without departing from the spirit and scope of the present invention as defined by the appended claims.

For example, although nitrogen gas is used for contactlessly holding the wafer, it is not necessarily limited to it and other inert gas such as He can be used. In addition, although formed in the center of the center port 100 is a blow-off outlet 151a for holding wafer, however, it can be replaced by a plurality of blow-off outlets. Gas-providing paths 151 and 152 and the liquid-providing paths 153 formed in the center port 100 can be holes that are formed in the center port, or aside from them, tubes of Teflon (registered trademark) can be used.

Furthermore, although in the above embodiments, nitrogen gas at approximately room temperature is used in the drying step of the wafer W, it is not necessarily limited to it. The time for drying the wafer W can be shortened by blowing off nitrogen gas or the like that is heated to a predetermined temperature.

Moreover, although the cleaning of a semiconductor wafer is described as an example in the above embodiments, the present invention is not necessarily limited to it. Besides semiconductor wafers, the present invention can be applicable to liquid crystal substrates, plasma substrates, or any plate-like member which can be contactlessly held by the Bernoulli Effect. Besides cleaning step, the present invention can be applicable to steps such as spin coating for forming a resist on a semiconductor wafer.

As described above, according to the substrate processing apparatus of the present invention, vibrations of the substrate to be processed and noise can be suppressed, and particle generation can be minimized. Moreover, because the processing, such as the cleaning of the substrate, can be performed while contactlessly holding the substrate, the substrate can be protected from particles or other contaminants and the high cleanliness of the substrate can be maintained.

What is claimed is:

1. A substrate processing apparatus comprising:
a fluid-providing apparatus which is stationarily arranged adjacent a surface of at least one blow-off outlet, said blow-off outlet provided for blowing off fluid, and
a rotating member capable of rotating about said fluid-providing apparatus, wherein said rotating member comprises:
a first rotating member comprising a main surface that opposes a substrate to be processed, and
a second rotating member being connected to said first rotating member and rotatably driven by a rotation-driving member,
wherein said fluid-providing apparatus and said at least one blow-off outlet are offset below the main surface of said first rotating member, and
wherein said substrate is held contactlessly above the main surface of said first rotating member and said fluid-providing apparatus when fluid is blown off from said at least one blow-off outlet.

2. The substrate processing apparatus of claim 1, wherein the amount of the offset between a surface comprising said at least one blow-off outlet and said main surface of said first rotating member is about 2 mm or less.

3. The substrate processing apparatus of claim 1, wherein said fluid-providing apparatus comprises a cylindrical blow-off portion, on the surface of which said at least one blow-off outlet is provided, and a first seal portion for forming a non-contact seal between it and said first rotating member;
wherein said first rotating member comprises a through hole, in the center of which said blow-off portion is provided, and a second seal portion that fits said first seal portion; and
wherein a gap is formed between said blow-off portion and said through hole, and fluid flows out from the gap.

4. The substrate processing apparatus of claim 3, wherein at least one shoulder portion having a radius smaller than a radius of said blow-off outlet is formed on the side of said blow-off outlet.

5. A substrate processing apparatus comprising:
a fluid-providing means which is stationarily arranged and on the surface of which a plurality of blow-off outlets are provided for blowing off fluid; and
a rotating means which is capable of rotating about said fluid-providing means, wherein said rotating means comprises:
a first rotating member comprising a main surface that opposes a substrate, and a second rotating member being connected to said first rotating member and rotatably driven; and
wherein said plurality of blow-off outlets comprise a first blow-off outlet located in the center, and at least one second blow-off outlet located about said first blow-off outlet, wherein said substrate can be contactlessly held above said first rotating member by blowing off gas from the first blow-off outlet, and liquid can be blown off from said second blow-off outlet to said contactlessly held substrate.

6. The substrate processing apparatus of claim 5, wherein one surface of said substrate is cleaned by the liquid that is blown off from said second blow-off outlet.

7. The substrate processing apparatus of claim 5, wherein said second blow-off outlet located about said at least one first blow-off outlet comprises a plurality of second blow-off outlets.

8. The substrate processing apparatus of claim 5, wherein said substrate processing apparatus comprises a nozzle above said rotating means and is capable of providing liquid to a second surface that is opposite to said one surface of said contactlessly held substrate.

9. A substrate processing apparatus comprises:
a fluid-providing apparatus having a first and a second diameters, wherein a plurality of blow-off outlets are formed on a surface of said first diameter and a first labyrinth seal portion is formed on a surface of said second diameter, the fluid-providing apparatus further comprising a providing port that is capable of providing fluid to at least said plurality of blow-off outlets; and
a rotating member being rotatably mounted to said fluid-providing apparatus;
wherein said rotating member comprises a main surface, in the center of which a through hole is formed, wherein the surface of said first diameter of said fluid-providing apparatus is located in said through hole, and said rotating member further comprises a second labyrinth seal portion that fits the first labyrinth seal portion;
wherein a first aperture is formed in said first labyrinth seal portion, and said first aperture is connected to said providing port through a first path; and
wherein a second aperture is formed in said second labyrinth seal portion, and said second aperture is connected to a second path, and said first aperture and said second aperture are spaced apart.

10. The substrate processing apparatus of claim 9, wherein the fluid provided from said providing port flows through said first path, said first aperture, and said first and second labyrinth seal portions and flows out from a gap between the surface of said first diameter and said through hole.

11. The substrate processing apparatus of claim 9, wherein said second aperture comprises a plurality of apertures, and said second path comprises a plurality of paths being connected to said plurality of apertures, and a plurality of fluid-draining outlets are formed on the side of said rotating member, and said plurality of paths extend in radial directions and connected to said plurality of fluid-draining outlets respectively, and the fluid that is provided from said providing port flows through said first path, said first aperture, and said first and second labyrinth seal portions and can be drained out from said fluid-draining outlets through said second aperture and said second path.

12. The substrate processing apparatus of claim 9, wherein said substrate processing apparatus further comprises a liquid-providing nozzle above said rotating member, and is capable of providing liquid by said liquid-providing nozzle to a second surface that is opposite to a first surface of a substrate.

13. The substrate processing apparatus of claim 9, wherein said liquid-providing apparatus comprises a sensor for detecting the presence of a substrate.

14. A substrate processing apparatus comprising:
a holding plane comprising a surface, on which a plurality of blow-off outlets is formed and which is arranged stationary, and a main surface that rotates about said surface, and
a fluid-providing apparatus to provide fluid to said plurality of blow-off outlets,
wherein, by contactlessly holding a substrate above said holding plane by fluid that is blown off from at least one blow-off outlet of said plurality of blow-off outlets, and by blowing off cleaning chemical solutions from at least one blow-off outlet of said plurality of blow-off outlets, one surface of the substrate that is held contactlessly is cleaned.

15. The substrate processing apparatus of claim 14, wherein a gap is formed between said surface and said main surface, and fluid is blown off from said gap.

16. A substrate processing method comprising the steps of:
placing a substrate above a holding plane which comprises a surface, on which a plurality of blow-off outlets are formed, and a main surface that rotates about said surface;
blowing off inert gas from at least one blow-off outlet of said plurality of blow-off outlets to contactlessly holding said substrate above said holding plane; and
blowing off chemical solutions for cleaning the substrate from at least one blow-off outlet of said plurality of blow-off outlets.

17. The substrate processing method of claim 16, wherein said surface is kept stationary, and said main surface is rotated, and said contactlessly held substrate is rotated together with said main surface.

18. The substrate processing method of claim 16, wherein fluid is blown off from the gap between the surface that is kept stationary and the main surface that is rotated.

19. The substrate processing method of claim 16, and further comprising blowing off pure water from at least one of said plurality of blow-off outlets for rinsing the substrate that is held contactlessly, after the cleaning step of said substrate.

20. The substrate processing method of claim 19, and further comprising blowing off inert gas from at least one of said plurality of blow-off outlets for drying the substrate that is held contactlessly, after said rinsing step.
